(19) United States
(12) Patent Application Publication
(10) Pub. No.: US 2007/0042819 A1
(43) Pub. Date: Feb. 22, 2007

(54) Wireless network shielding system and method

(75) Inventors: Jaime Li, Martinsville, VA (US); Deron Simpson, Finksburg, MD (US); Lisa Y. Winckler, Collinsville, VA (US); Ronald J. Waranowski, Finksburg, MD (US)

Correspondence Address: HOGAN & HARTSON LLP;IP GROUP, COLUMBIA SQUARE, 555 THIRTEENTH STREET, N.W., WASHINGTON, DC, 20004, US

(73) Assignees: ASTIC Signals Defenses L.L.C; CP Films, Inc.

(21) Appl. No.: 11/485,632

(22) Filed: Jul. 13, 2006

Related U.S. Application Data
(60) Provisional application No. 60/698,487, filed on Jul. 13, 2005.

(51) Int. Cl. H04M 1/00

(52) U.S. Cl. 455/575.5

(57) ABSTRACT

An enhanced wireless network system including a visible-light transparent, transmission shielding component for application to or incorporation in windows to create a shielded wireless network operation area. The shielding component enhances network performance by substantially reducing extraneous electromagnetic interference and enhances network security by substantially containing electromagnetic transmissions to desired areas. The shielding component may comprise several alternating layers of metal, to substantially attenuate transmissions to varying degrees, including attenuation of 20 to 50 db in the 1 MHz to 100 GHz range and beyond, while simultaneously permitting substantial transmission of visible light (such as 15-55%).

### CROSS REFERENCE TO RELATED APPLICATIONS

This application claims priority under 35 U.S.C. § 119 to Provisional Application No. 60/698,487, filed Jul. 13, 2005, which application is incorporated herein by reference in its entirety.

### BACKGROUND OF THE INVENTION

1. Field of the Invention

This application relates generally to a system and method for improved wireless networking through the use of electromagnetic shielding technology. Specifically, performance and security of local area wireless networks may be improved by the application of electromagnetic blocking films to windows, thereby permitting improved management of the local area electromagnetic spectrum. These blocking films permit transmission of substantial quantities of visible light, while substantially blocking one or more non-visible frequency ranges, thereby reducing electromagnetic interference and increasing data security.

2. Discussion of the Related Art

Wireless local area networks are known and widely adopted for telecommunications including the entire IEEE 802.11 series of wireless local area network specifications. Wireless networks need not be confined to any particular structure or area. For example, a wireless network may be operated in an area without walls, doors, ceilings, or even a roof.

Films for the reduced transmission of ambient visible light are known in the art. Such films may be used to reduce light intensity to comply with work environment regulations or provide improved thermal management of facilities. One such example is the Vista® V14, which permits approximately 12% visible light transmission. Although such films may reduce visible and UV light transmission, such films do not adequately attenuate the much broader range of wavelengths that are presently used and likely to be used in the future for wireless network transmissions.

Films have also been applied to windows for other purposes, including safety and/or blast resistance. The application of such films to windows may prevent or reduce the shattering of the window material in the event the window material is presented with unusually strong forces.

As local wireless networks become more prevalent, the performance of wireless networks may be adversely impaired through the interference of extraneous electromagnetic signals originating from other wireless networks or other extraneous sources.

Moreover, as greater amounts and types of data are transmitted over such wireless networks, the potential for interception and compromise of such data is of increasing concern. Various embodiments of the present invention seek to address these and other concerns. Furthermore, in addition to the above-described threat of intercepting the wireless signal exists, more sophisticated techniques pick up the wireless signal, regardless if encrypted or not, to be a modulated carrier for other signals to ride on, even emanated from the same computer running WEP (encryption). This technique defeats encryption without breaking keys, etc. Accordingly, there exists a need for a system and method to prevent the undesired emission of wireless networks outside of a structure without impairing the operation of the wireless network within the structure.

### SUMMARY OF THE INVENTION

A system is described for improved wireless local area network performance, wherein a local area network operation area (LANOA) is shielded from interference with extraneous wireless networks or other electromagnetic sources. Moreover, transmissions of the wireless local area network signals to areas outside of the shielded LANOA is substantially reduced. In one implementation, a multilayer film transparent to visible light (permitting the transmission of a substantial amount of visible light—for example, from approximately 3 to approximately 95%), but opaque to one or more non-visible light wavelengths (blocks the transmission of substantially all light of one or more ranges of non-visible wavelengths—for example, approximately 20 dB to 50 dB attenuation for wavelengths in the range of 30 MHz to 10 GHz and beyond), is applied to the windows of an existing structure in which improved wireless network operations are desired. This system has a two distinct benefits for the improved operation of wireless networks.

First, the system may substantially exclude undesirable electromagnetic transmissions originating from outside the shielded network operation area (NOA) from entering the network operation zone. These undesirable electromagnetic transmissions may interfere with the optimal operation of wireless networks. Indeed, entities could potentially direct undesirable electromagnetic transmissions into a facility operating a wireless network with the intent to disrupt network operations.

Second, the system may substantially reduce the transmission of the electromagnetic signals from within the shielded network operation area to areas outside of the shielded network operation area. This may beneficially enhance the security of the shielded wireless network by substantially reducing the likelihood that such electromagnetic signals may be intercepted by those outside of the shielded network operations area.

Third, the system will allow the wireless network administrator to increase the signal strength of the network to provide a more robust signal to the most remote users within the shielded NOA. Otherwise, wireless networks deployed in non-shielded areas require the administrators to strictly regulate the network signal strength such that the minimum amount of electromagnetic signal leakage occurs outside the NOA, thus leaving remote users with minimal signal strengths or impacting the distances of the remote users.

Some embodiments of the present invention permit the creation of a shielded network operation area within existing structures. In such implementations, the electromagnetic blocking film may comprise a thin film that may be affixed to existing window structures.

Other embodiments of the present invention permit the creation of windows that incorporate or integrate the electromagnetic blocking film prior to their installation. Such films may be applied to a window's exterior facing surface, interior facing surface, both the exterior or interior surfaces, suspended between the panes or be embedded within one or more window panes. The film may also be employed in a drawn shade, curtain or blinds.

Embodiments of the present invention provide wireless networking shielding system and method including applying an electromagnetic blocking filter to an enclosure section, wherein the electromagnetic blocking filter attenuates emissions in the frequency band from the wireless network through the section by at least 30 dB and transmits at least 3% of visible light. The frequency band includes a range of 30 MHz to 10 GHz.

Optionally, the blocking filter is flexible film type. For example, the electromagnetic blocking filter includes a hardcoat material, a film substrate, a laminating adhesive, a sputtered stack, a second film layer, a mounting adhesive; and a release film. The film substrate may be PET, PEN, or polycarbonate. Alternatively, the electromagnetic blocking filter is directly deposited on to the enclosure section.

The electromagnetic blocking filter may include two alternating layer pairs having a dielectric or metal oxide layer and a metal layer.

Optionally, the electromagnetic blocking filter attenuates emissions in the frequency band through the section by at least 42 dB. The electromagnetic blocking filter may include four layer pairs, the layer pair including a dielectric or metal oxide layer and a metal layer. The electromagnetic blocking filter may further include at least one additional dielectric or metal oxide layer to protect the last metal layer

Optionally, the electromagnetic blocking filter attenuates emissions in the frequency band through the section by at least 50 dB. For example, the electromagnetic blocking filter may include eight of the layer pairs.

Optionally, the electromagnetic blocking filter including a flexible transparent sheet configured for attachment to a glazing of a window. For example, the electromagnetic blocking filter further may include a safety film adhered to the glazing.

Optionally, electromagnetic blocking filter may include a first and a second filter portion (such as a two separated dielectric/metal stacks, with these first and second filter portions being spaced apart from each other.

Each of the spaced apart filter portions may be embedded in spaced apart layers of polyvinylbutyral, wherein each polyvinylbutyral layer is sandwiched between layers of glass or plastic window glazing.

The electromagnetic blocking filter may include an upper layer including a first outer glass sheet joined to a first of the spaced-apart filter portions by a layer of PVB, and a lower layer including a second outer glass sheet joined to a second of the spaced-apart filter portions by a second layer of PVB, where the first and second of the spaced-apart filter portions s is adhesively secured to each other by a third layer of PVB or by an adhesive layer, and where the third layer of PVB and the adhesive having a thickness which determines a distance between the spaced-apart filter portions. The third layer of PVB or the adhesive may be electrically conductive. Similarly, the electromagnetic blocking filter may include a layer of PVB or adhesive between the two filter portions.

The electromagnetic blocking filter may include a sputtered dielectric or metal oxide layer and a metal layer. The dielectric or metal oxide layer may include In₂O₃, TiO₂, Nb₂O₅, Ta₂O₅, SnO₂, ZnO or indium tin oxide (ITO). The metal layer may include silver, gold, copper, aluminum or other known attenuators of EMI (electromagnetic interference). The electromagnetic blocking filter further may include an intermediate cladding layer or an intermediate adhesion layer.

The electromagnetic blocking filter may optionally be applied to a first surface of the section and a second portion of the electromagnetic blocking filter to a second surface of the enclosure section.

In other embodiments, a similar configuration is used to prevent entry of stray, undesired radiation rather than preventing undesired exit of the wireless networking signals. The electromagnetic blocking filter attenuates emissions in the frequency band entering the enclosure through the section by at least 30 dB.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 is a diagram of an unshielded wireless network.

FIG. 2 is a diagram of a shielded wireless network wherein the exterior facing surface of windows have been retrofitted with electromagnetic blocking films.

FIG. 3 is a diagram of a preferred embodiment of a 42 dB electromagnetic blocking film for window retrofitting.

FIG. 4 is a diagram of a sputtered stack component of a preferred embodiment of electromagnetic blocking film.

FIG. 5 is a diagram of a preferred embodiment of a 42 dB electromagnetic blocking film on glass.

FIGS. 6-7 are diagrams of preferred embodiments of a dual-layer electromagnetic blocking film alone and mounted to glass respectively.

FIGS. 8-10 are diagrams of alternative embodiments of windows using the electromagnetic blocking film of FIGS. 3-7.

FIGS. 11A-11C and 12 are diagrams of windows having integral electromagnetic blocking layers.

FIG. 13 is a diagram of a window using laminated glass incorporating an electromagnetic blocking layer.

### DETAILED DESCRIPTION OF THE PREFERRED EMBODIMENTS

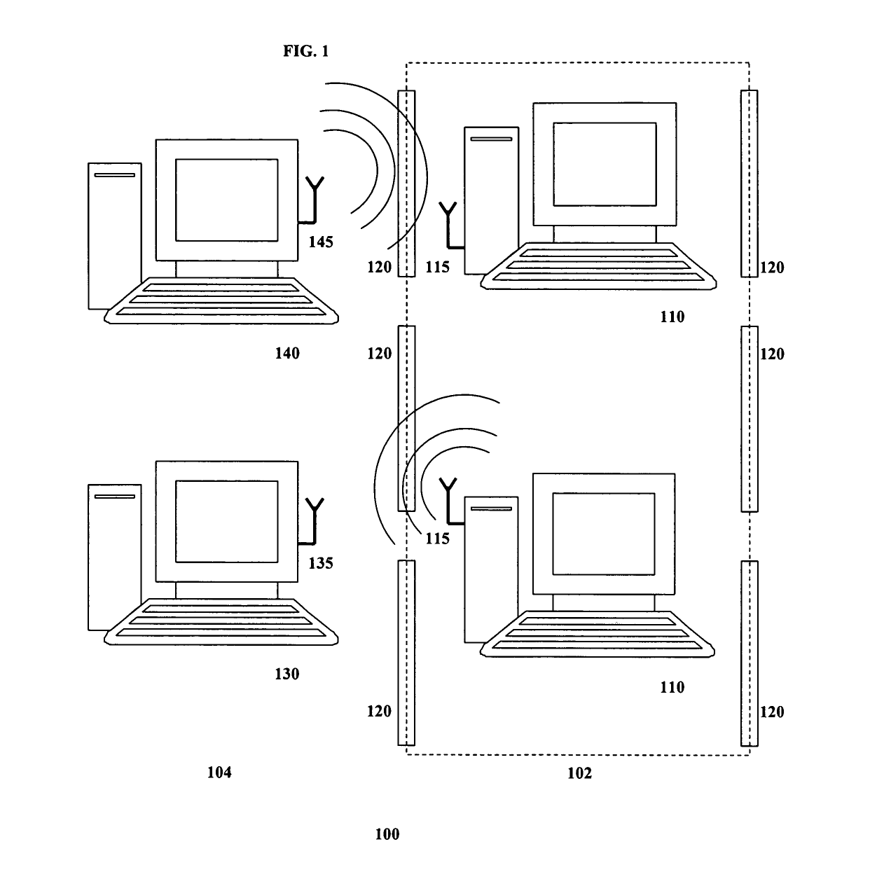

FIG. 1 depicts an unshielded wireless network system 100 including an unshielded network operations area 102 and an external area 104. The unshielded network operating area 102 may include workstations 110 with wireless transmission capability 115 and windows 120.

Although one preferred embodiment may include a plurality of workstations 110 in the network operations area (NOA), it is understood that the present invention may beneficially serve any NOA containing one or more devices that transmit electromagnetic signals including, for example, cellular phones, pagers, personal digital assistances (PDS), Blackberry e-mail devices, printers, wired telephones (which may broadcast weak signals through their wires), any type of wireless network, or any electromagnetically transmitting object including RFID tags and the like. Such electromagnetic signals may be intentionally or unintentionally generated and, although typically intended for the communication of information, need not always be so intended.

Examples of intended electromagnetic transmissions vary widely, but typically are wireless LAN (WLAN) transmissions. Although proprietary transmitters may be used, commercial off the shelf systems, available from companies such as Cisco or NetGear, are preferred for their reduced cost. These systems preferably encrypt their wireless communications using any encryption scheme, now known or hereafter developed. These vendors also offer varying methods of authentication for security purposes however both encryption and authentication do not provide the protection from “free space eavesdropping” as opposed to cyber hacking or eavesdropping.

Examples of unintended electromagnetic transmissions may include, for example, signals broadcast by a cable connecting a keyboard to a workstation, signals broadcast from a computer monitor or even the electromagnetic radiation generated by a human body.

The external area 104 is the area outside of the network operation area 102. The broadcast of electromagnetic signals from the network operation area 102 into the external area 104 generally serves no benefit (as there are no devices that are intended to receive the broadcast signals) and may indeed be detrimental, when, for example, such broadcast signals are intercepted. As depicted, another device, depicted as a workstation 130 with reception capability 135, may intentionally or unintentionally intercept the broadcast electromagnetic signal. When the broadcast signals contains sensitive information, the intercepting entity may undesirably acquire the sensitive information, thereby compromising the security of the transmitted information.

Another undesirable aspect of the unshielded wireless network 100 is the interference of multiple signals. A device located outside of the unshielded network operation area, depicted as workstation 140 with broadcast capability 145, may transmit electromagnetic signals into the unshielded network operations area. These signals may disrupt or reduce the performance of the unshielded wireless network.

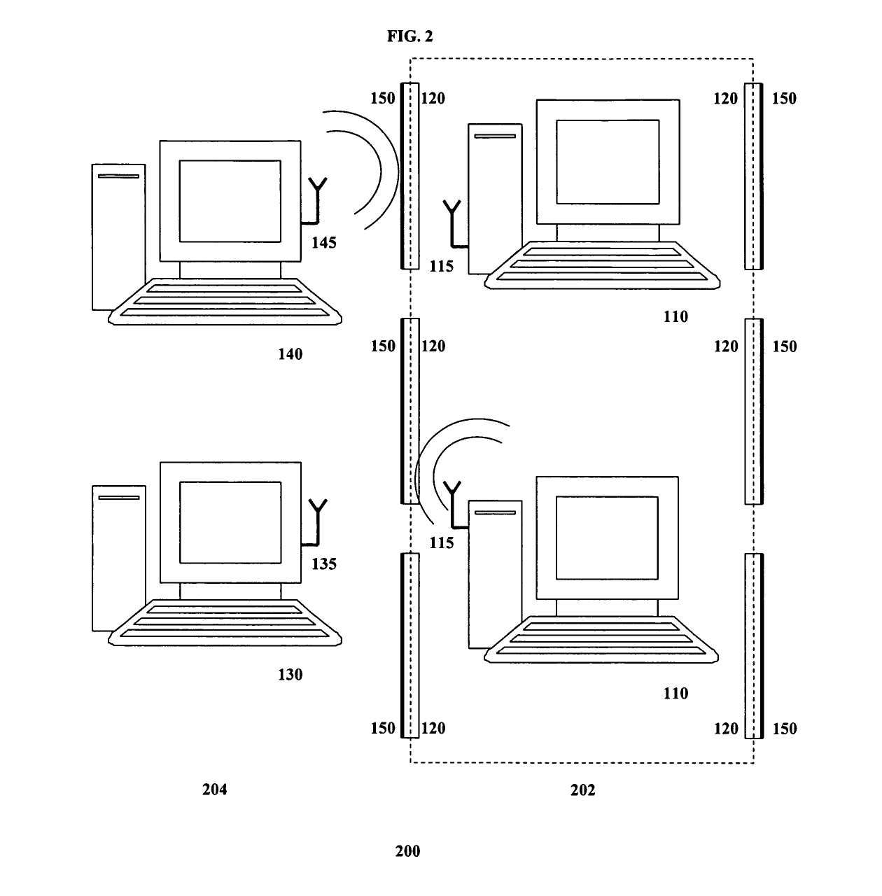

FIG. 2 is a shielded wireless network 200, including a shielded network operations area 202 and an external area 204. The shielded wireless network 200 is distinct from the unshielded wireless network 100 in that electromagnetic blocking film 150 has been added to exterior surface of windows 120. The film could be put on any of the surfaces of the glass to be effective—one layer of the 42 dB could be put on two surfaces and get the same results as the 50 dB film.

The electromagnetic blocking film 150 permits the transmission of at least some non-trivial portion of visible light. Preferably, the electromagnetic blocking film 150 transmits at least 15% of visible light, although visible light transmissions of 3% or less may be suitable for some applications. Significantly, to improve the operation of the wireless network within the network operation area, the electromagnetic blocking film 150 substantially attenuates one or more frequencies used for wireless networks. Preferably, the electromagnetic blocking film 150 attenuates the electromagnetic signals by 20 dB in the frequency range of 30 MHz to 10 GHz. More preferably, the electromagnetic blocking film 150 attenuates the electromagnetic signals by 30 dB in the frequency range of 30 MHz to 10 GHz. Even more preferably, the electromagnetic blocking film 150 attenuates the electromagnetic signals by 42 db in the frequency range of 250 MHz to 10 GHz. Most preferably, the electromagnetic blocking film 150 attenuates electromagnetic signals by 50 db in the frequency range of 1 MHz to 100 GHz. and beyond?

Electromagnetic signals broadcast by a device in the external area 204, depicted as a workstation 140 with broadcast capability 145, may be effectively excluded from the network operations area 202 through the attenuation resulting from the electromagnetic blocking film 150.

Similarly, electromagnetic signals broadcast from a device within the network operations area 202, depicted as a workstation 110 with broadcast capability 115, may be effectively contained within the network operation area 202 through the attenuation of such signals by the electromagnetic blocking film 150.

It is realized that a fraction of signals may penetrate the structure enclosing the network operation area 202 through portions not contain the electromagnetic blocking film 150. Certain embodiments of the present invention contemplate that electromagnetic shielding is applied to these other portions of the structure. Other embodiments need not have electromagnetic shielding applied to these other portions, as the materials including the structure itself are effective at adequately attenuating electromagnetic signals although not transparent and therefore not suitable for use on window glazing.

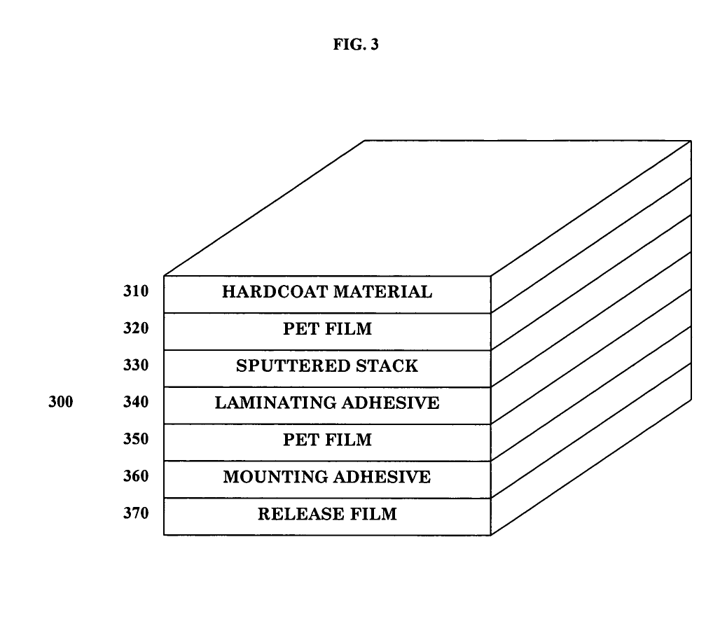

FIG. 3 is a diagram of a preferred embodiment of 42 dB electromagnetic blocking film 300 for window retrofitting. It may include a hardcoat material 310, a Polyethylene Terephthalate (PET) film 320, a sputtered stack 330, a laminating adhesive 340, a PET film layer 350, a mounting adhesive 360, and a release film 370.

It should be understood that the various layers of material including disclosed in the preferred embodiments herein need not be of equal or uniform thickness. Moreover, it should be understood by one of ordinary skill in the art that the various layers of material need not be arranged in the exact order, although typical practical considerations in view of the particular use of the film will suggest certain arranges as being the most feasible or beneficial.

The hardcoat material 310 provides a protective coating for the electromagnetic blocking film. The hardcoat layer may, for example, be an epoxy, resin, or any natural or synthetic material which provides adequate protection to the other layers of the electromagnetic blocking film 300 depending on the application for which it is used. The hardcoat material should be substantially transparent to visible light. A suitable hardcoat composition includes the hardcoat described in U.S. Pat. No. 4,557,980, which is hereby incorporated by reference.

The PET film 320 may comprise any suitable polyethylene terephthalate film commercially available providing that its transparency and haze levels are suitable for the application. Other transparent polymeric (or non-polymeric) films may be suitable as well such as polycarbonate, polyethylene naphthalate, etc. The PET film 320 should be substantially transparent to visible light. Preferably, the PET film 320 may include DuPont 454 or equivalent available from DuPont Teijin Films and maintains a thickness of approximately ½ mil or 12.5 microns to 10 mils or 250 microns.

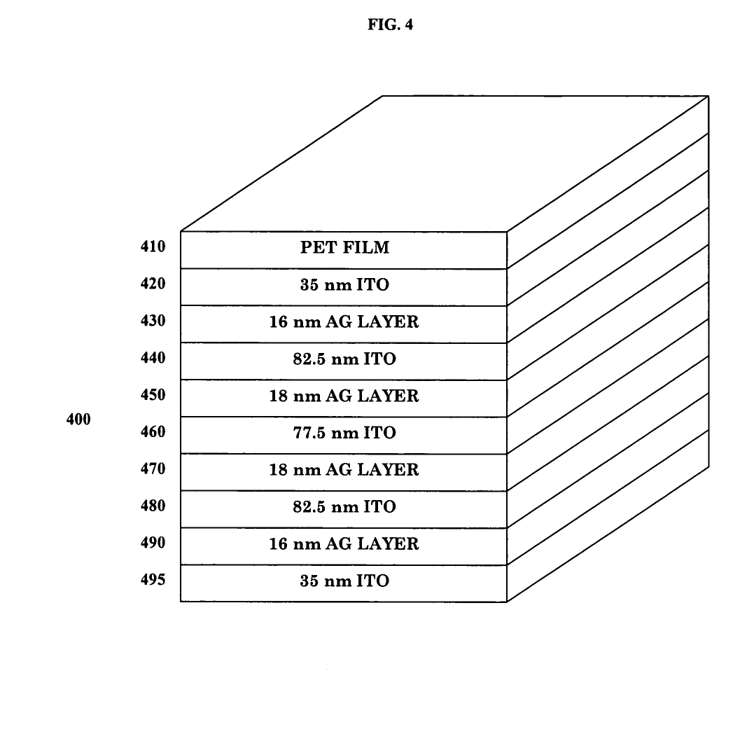

The sputtered stack 330 is depicted in greater detail in FIG. 4 and described in the corresponding discussion of FIG. 4.

The laminating adhesive 340 may be any adhesive that permits substantial transmission of visible light. Preferably, the laminating adhesive 340 may include Adcote 76R36 with catalyst 9H1H, available from Rohm & Haas, and may be applied at approximately 1.0-2.0 pounds/ream coat weight.

The PET film 350 may be identical to the PET film 320 or may be distinct, including the same or different material as PET film 320 or the same or different thickness as PET film 320. Preferably, PET film 320 and PET film 350 are identical, as this simplifies the manufacturing process.

Additionally or optionally PET film 350 may have UV absorbers and/or dyes, nanoparticles or pigments either coated onto one or both of its surfaces or have them contained in the film itself. This is applicable to PET film 320 as well.

The mounting adhesive 360 may be any adhesive that will permit substantial transmission of visible light when applied. Preferably, the mounting adhesive may include a pressure sensitive adhesive such as National Starch 80-1057 and is applied at approximately 3.5-12.0 pounds/ream coat weight or a non-pressure sensitive adhesive such as Adcote 89r3 available from Rohm & Haas.

The release film 370 may be any material that removably separates from the mounting adhesive layer. The release film protects the mounting adhesive 360 until the time of installation. At such point, the release film is removed, thereby exposing the mounting adhesive 360 so that the mounting adhesive may contact the surface to which the electromagnetic blocking film is to be applied.

FIG. 4 is a preferred embodiment of a sputtered stack 400 that may be employed within the electromagnetic blocking film depicted in FIG. 3 corresponding to the sputtered stack 330 (or in sputtered stacks 630, 660 in a double layer film 600 or in a sputter stack 1010 in the composite glass 1100). The sputtered stack 400 may include a PET film 410, a 35 nm nanometer thick layer of Indium Tin Oxide (ITO) 420, a 16 nm silver layer 430, a 82.5 nm ITO 440, and 18 nm silver layer 450, a 77.5 nm ITO 460, an 18 nm silver layer 470, a 82.5 nm ITO 480, a 16 nm silver layer 490, and a 35 nm ITO 495. It should be appreciated that the particular ordering of these layers may be modified as desired.

It is understood that the layers of the electromagnetic blocking film 150 and the sputtered stack 400 may be manufactured by any method heretofore known or subsequently developed. The preferred method for manufacturing or applying this stack is vacuum deposition known in the art as sputtering. However, other known or future developed methods of manufacture can also be employed, including, for example, vapor deposition or wet coating.

The PET film 410 may be the same or similar to the PET film described above. The PET film 410 is preferably substantially transparent to visible light.

The ITO layers 420, 440, 460, 480, and 495 preferably comprise indium tin oxide. Similarly, the silver layers 430, 450, 470, and 490 are preferably pure silver. The various metal layers 420-495 may be applied by sputtering, chemical vapor deposition (CVD), or any other method heretofore known or subsequently developed. It should be appreciated, however, that a variety of other filtering metals, alloys or combinations thereof, including, for example, gold, palladium, copper, etc. are known in the field of window film and electromagnetic filtering and may be employed alternatively in the present invention instead of pure silver. Other metal oxides or dielectrics could be used in place of the ITO. Similarly, the particular thickness of the particular film stack layers 420-495 may be modified according to simple trial and error measurements as needed to achieved desired performance criteria. In particular, different thicknesses and materials attenuate different wave lengths. In the same way, while nine particular alternating ITO and silver layers 420-495 are disclosed, the particular number and ordering of layers may be modified according to simple trial and error measurements as needed to achieved desired performance criteria.

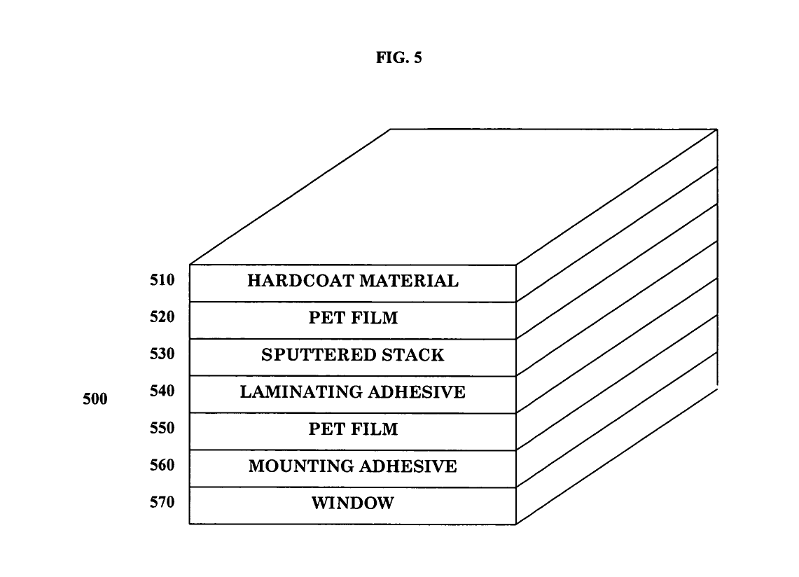

FIG. 5 is a preferred embodiment of an installed electromagnetic shielding film 500. Installed on an existing window 570. The installed electromagnetic blocking film may include a hardcoat material 510, a Polyethylene Terephthalate (PET) film 520, a sputtered stack 530, a laminating adhesive 540, a PET film layer 550, a mounting adhesive 560, and a window 570. The window 570 is preferably glass, but may be plastic or any other transparent or translucent material.

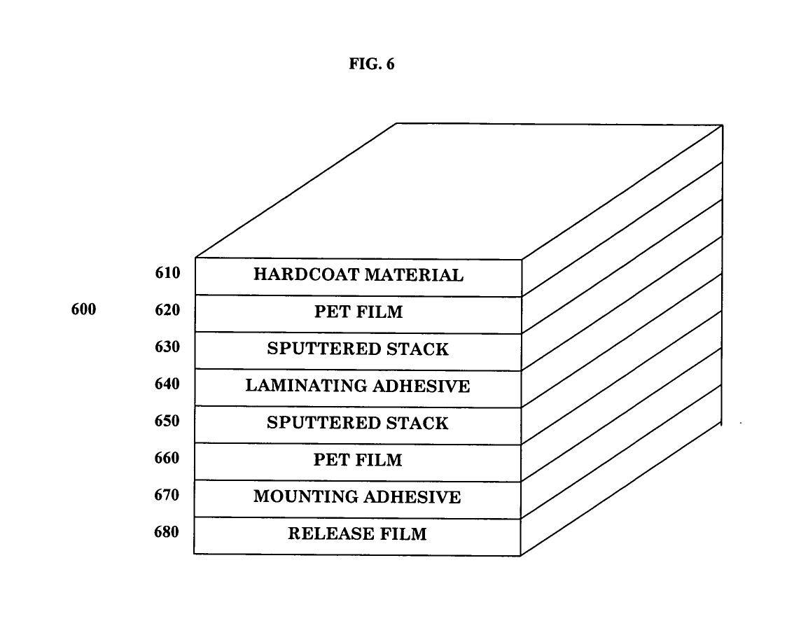

FIG. 6 is a preferred embodiment of a dual-layer electromagnetic blocking film 600. This embodiment may include a hardcoat material 610, a PET film 620, a sputtered stack 630, a laminating adhesive 640, a sputtered stack 650, a PET film 660, a mounting adhesive 670, and a release film 680. The two sputtered stacks 630, 650 may be of the kind depicted in FIG. 4.

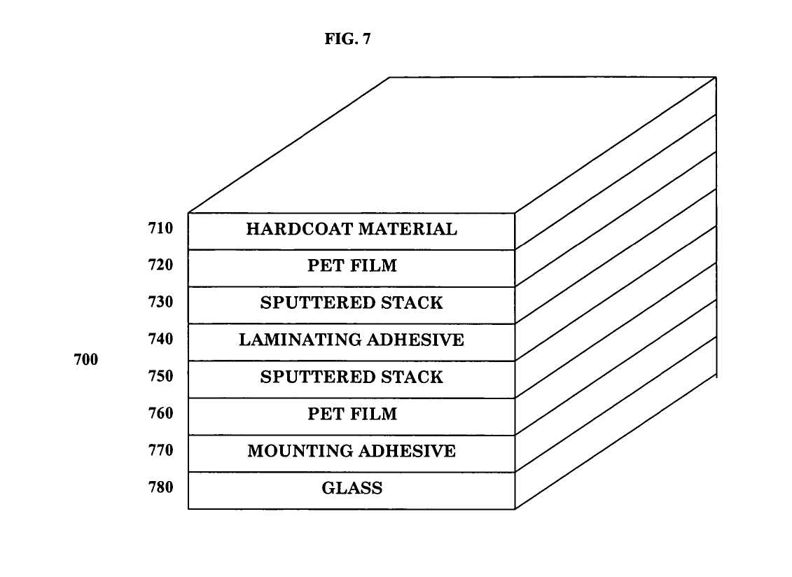

FIG. 7 depicts a dual-layer electromagnetic blocking film 700 including a hardcoat material 710, a PET film 720, a sputtered stack 730, a laminating adhesive 740, a sputtered stack 750, a PET film 760, a mounting adhesive 770, and glass 780.

In another embodiment of the present invention, a visible light transparent electromagnetic blocking film 150 is used to attenuate a wireless radio frequency signals in the frequency range of 30 MHz to 10 GHz by 50 dB. To that end, the electromagnetic blocking film 150 may include a sputtered, laminated product on PET film, which may be retrofitted onto glass or plastic windows. The electromagnetic blocking film 150 may effectively reduce the ingress or egress of electromagnetic signal through such windows. This embodiment of the transparent electromagnetic blocking film 150 preferably provides approximately 30% visible light transmission (VLT). This embodiment can also, if necessary, block UV up to 400 nm, and can be modified to permit more or less light transmission depending on requirements.

In one particular embodiment containing two sputtered stack layers, electromagnetic transmission at 800 nm was measured to be approximately zero, visible reflection was approximately 15-17%, sheet resistance was approximately 0.50-0.51 ohms/square (for two layers laminated together), and attenuation was approximately 50 dB for 30 MHz to 10 GHz for two layers of laminated sputtered material.

The electromagnetic blocking film 150 can be employed in any of a variety of ways. The electromagnetic blocking film 150 may be applied to existing windows as part of a retrofit. The electromagnetic blocking film 150 may be applied to newly manufactured glass or plastic panes. The electromagnetic blocking film 150 may be wholly incorporated as part of the original manufacturing process of the glass or plastic window panes. In other variations, the electromagnetic blocking film 150 may be suspended in between glass panes or used as a hanging shade material.

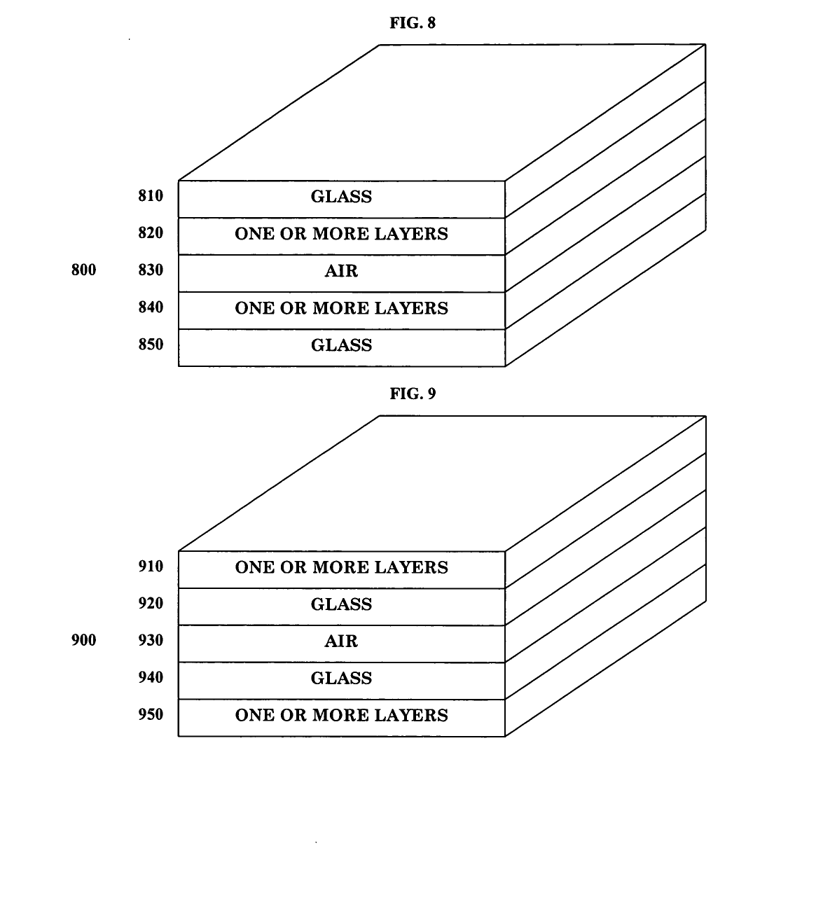

FIG. 8 depicts one embodiment of a product 800 including a glass layer 810, one or more film layers 820, an air gap 830, one or more film layers 840, and a glass layer 850. The one or more film layers 820, 840 may be either portions of certain layers of a sputtered stack, for example sputtered stack 400, or may be an entire electromagnetic blocking film such as, for example, electromagnetic blocking film 300 or dual-layer electromagnetic blocking film 600.

FIG. 9 depicts one embodiment of a product 900 including one or more film layers 910, a glass layer 920, an air gap 930, a glass layer 940 and one or more film layers 950. The one or more film layers 910 and 950 may be either portions of certain layers of a sputtered stack, for example sputtered stack 400, or it may be an entire electromagnetic blocking film such as, for example, electromagnetic blocking film 300 or dual-layer electromagnetic blocking film 600. For example, as suggested above, one or more film layers 910 and 950 may be each be separate layers of the 42 db film layer combinations 300.

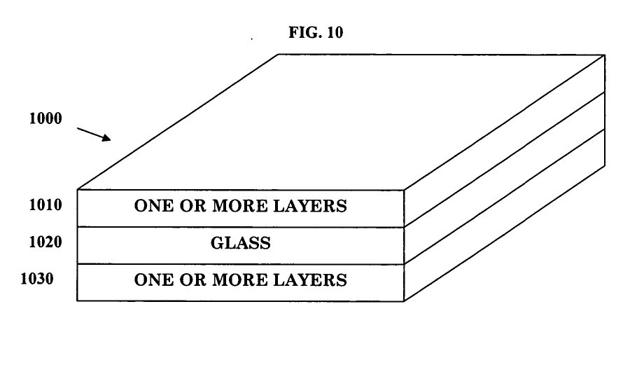

FIG. 10 depicts one embodiment of a product 1000 including a glass layer 1020, a first combination of one or more film layers 1010, and a second combination of one or more film layers 1030. The one or more film layers 1010 and 1030 may be either portions of certain layers of a sputtered stack, for example sputtered stack 400, or it may be an entire electromagnetic blocking film such as, for example, electromagnetic blocking film 300 or dual-layer electromagnetic blocking film 600.

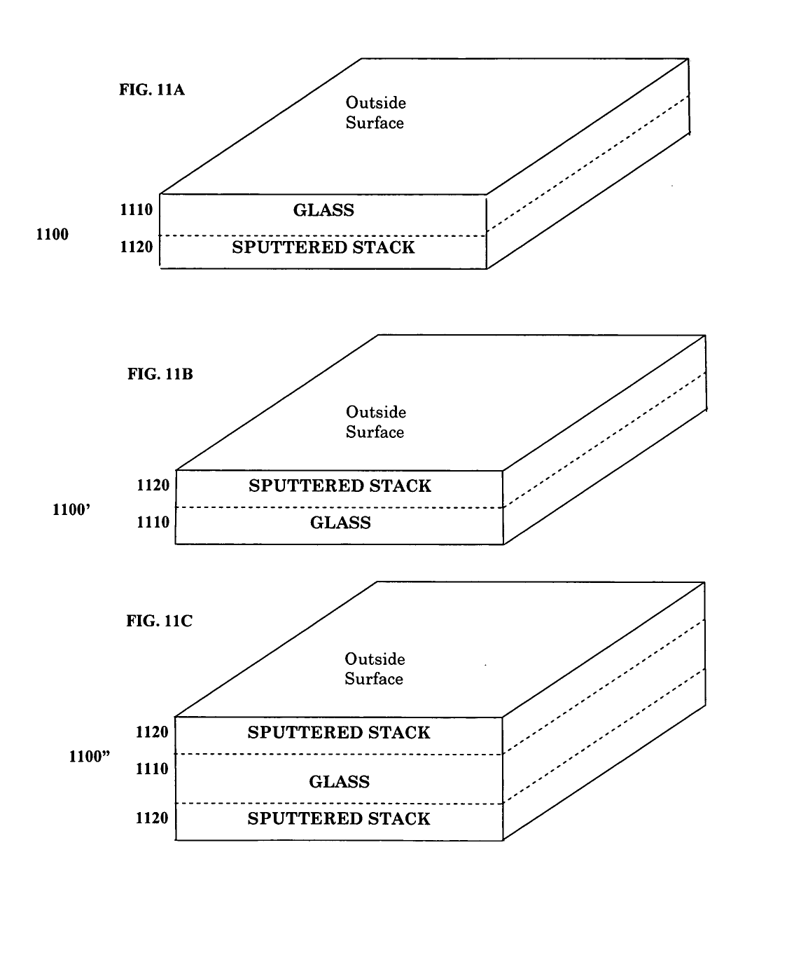

Referring now to FIGS. 11A-11C, a composite glass product 1100, 1100′ or 1100″ including a glass layer 1110 with integral filtering layers such as a sputtered stack 1120 configured on an interior surface (composite glass product 1100 in FIG. 11A), an exterior surface (composite glass product 1100′ in FIG. 11B), or both exterior and interior surfaces (composite glass product 1100″ in FIG. 1C). The sputtered stack 1120 may correspond to all or portions of the sputtered stack 400 attached to the glass layer 1110 by vacuum deposition. As in the above examples, it should be appreciated that the sputtered stack 1120 may incorporate various materials and layers of varying configuration and that other attachment techniques such as vapor deposition or wet coating may be employed. For example, sputtered stacks 1120 corresponding to sputtered stack 400 may be attached to each side of the glass 1110 to form a window structure 1100″ having 50 db performance.

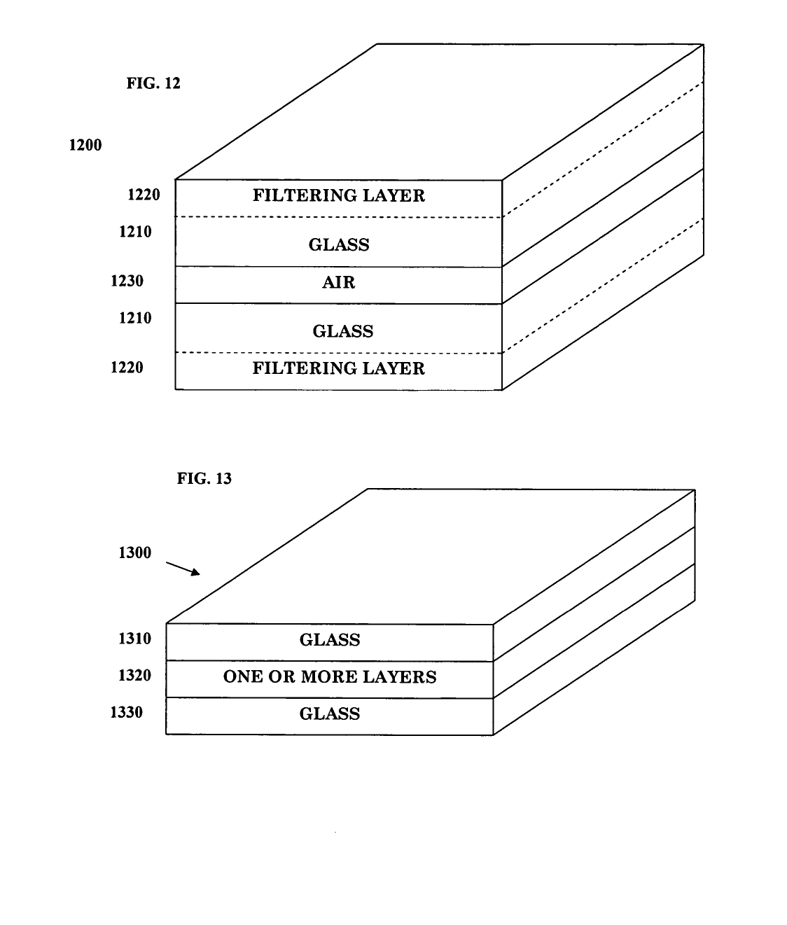

Likewise a composite window structure 1200 depicted in FIG. 12 may be used, where multiple glass layers 1210, typically separated by an air layer 1230, each have an integral filtering layer 1220. The filtering layer 1220 typically corresponds to all or portions of the sputtered stack 400, or known electromagnetic filtering equivalences thereof, attached to the glass layer 1210 by vacuum deposition or other known manufacturing techniques. For example, sputtered stacks 1220, each corresponding to sputtered stack 400, may be attached to the glass layers 1210 to form a glass structure 1200 having 50 db performance. Furthermore, while the displayed embodiment applies the filtering layers 1220 to the exterior surfaces of the glass layers 1210, the filtering layers 1220 may obviously be applied to the interior surfaces or other orientations.

It should be appreciated that the various embodiments of the present invention may be configured as known in the field of architectural and structural design. For example, FIG. 13 depicts a laminated glass 1300 having two layers of glass 1310 and 1330 sandwiching a filtering layer 1320. The filtering layer 1320 may be either portions of certain layers of a sputtered stack such as sputtered stack 400 or may be an entire electromagnetic blocking film such as either electromagnetic blocking film 300 or dual-layer electromagnetic blocking film 600. Obviously, this configuration may be expanded to include three or more glass layers, each sandwiching filtering layers that combine to perform the desired wireless network attenuation of the present invention, such as providing a portion of the sputtered stack 400 between each of the glass layers. In the same way, the embodiments of the present invention may be expanded to include other configurations, such as suspended film in glass structures.

Of course it is understood that the exact arrangement of layers need not be arranged exactly as shown in the figures, but may be arranged according to the desired use or particular needs of any given application. Such arrangements may include, for example, additional layers (glass, plastic or film), the elimination of particular layers, or the alteration of the order in which the layers are combined.

The films can be put, for example, anywhere on one or more of the surfaces of glass or other glazing to get the same or similar effects. One will recognize that numerous combinations of coated glazing materials and films may be used to achieve the same or similar result.

It is also understood that the present invention may employ sputtered glass, various glazing materials, plastic films or any combination of these or other materials. Moreover, the term “film” can be one or more layers added to glass by any process.

Films or layers may be laminated to polyvinyl butyral (PVB) or other material such as polyurethane (PUR) that sticks to the glass or glazing material. A sputtered film or layer may be laminated between PVB sheets or other materials that stick to the glazing and then laminated to or between glass sheets or other glazing. Layers may be deposited directly on glass or plastic glazing by any means appropriate. Alternatively, low emission glass may be used in combination with an attenuating film on the other glass or glazing surfaces.

Ultraviolet light blocking materials may also be employed in the stacks, layers, and films of the present invention.

In other embodiments, the wireless network shielding system of the present invention may be terminated or grounded in its application. For example, the sputtered stack may be directly connected or indirectly connected by a conductive adhesive (not illustrated) to a conductive structure, such as a metal window frame leading to ground. In other embodiments, several units of the wireless network shielding system may be electrically connected, thereby forming a conductively unified composite structure. For example, the various glass structures of the present invention may be incorporated into known suspended glass assemblies (not illustrated) that fix together a matrix of glass panes joined with metallic connectors, thereby avoiding the use of metal frames or mullions.

It will be understood that this invention has applicability beyond enhancing wireless network functionality. The electromagnetic blocking film may be beneficially employed in facilities where increased security is desired, such as diplomatic, defense, or governmental facilities in general, and advanced research facilities (both public and private) such as corporations, universities or national laboratories. The electromagnetic blocking film may be used to comply with regulatory requirements concerning the broadcast of electromagnetic signals or the reduction of electromagnetic signals in particular areas (such as hospitals, aircraft, ships, buildings, automobiles, tents, or even windows at front of movie theaters, for example) where extraneous electromagnetic signals are harmful or undesirable. One particularly beneficial application of the present includes the protection or management of radio frequency identification (RFID) signals (by preventing the reading of certain RFID tags or by reducing electromagnetic interference from other wireless networks or signals when attempting to read a particular RFID tag). This application may be used, for example, in warehouses or stores.

Thus, it is apparent that numerous embodiments and methods employ the present invention. These include a method for enhancing wireless local area network performance which may comprise: applying a visible-light transparent, non-visible light electromagnetic blocking film to a transparent window for the blocking of non-visible electromagnetic radiation.

Alternatively, an enhanced wireless local area network may comprise: an electromagnetic transmission device located in a network operation area, wherein the network operation area is at least partially enclosed by a transparent window, the transparent window having a visible-light transparent, non-visible light blocking electromagnetic blocking film.

Alternatively, a visible light transparent electromagnetic blocking film may comprise: a release film layer; a mounting adhesive layer adjacent to the release film layer; a first PET film adjacent to the mounting adhesive layer; a laminating adhesive layer adjacent to the first PET film; a sputtered stack adjacent to the laminating adhesive layer, wherein the sputtered stack may include a plurality of layers of metal; a second PET film adjacent to the sputtered stack; a hardcoat adjacent to the second PET film.

### CONCLUSION

While the invention has been described with reference to an exemplary embodiments various additions, deletions, substitutions, or other modifications may be made without departing from the spirit or scope of the invention. Accordingly, the invention is not to be considered as limited by the foregoing description, but is only limited by the scope of the appended claims.

What is claimed:

1. A wireless networking shielding method comprising the steps of:
providing a wireless network, wherein the wireless network operates in a frequency band of electromagnetic emissions;
positioning the wireless network within an enclosure having at least one section that is substantially transparent to the frequency band of electromagnetic emissions;
applying an electromagnetic blocking filter to said enclosure section, wherein said electromagnetic blocking filter attenuates emissions in the frequency band from the wireless network through said section by at least 30 dB and transmits at least 3% of visible light.

2. The method of claim 1, wherein said frequency band includes a range of 30 MHz to 10 GHz.

3. The method of claim 1 where the blocking filter is flexible film type.

4. The method of claim 3, wherein the electromagnetic blocking filter comprises:
a hardcoat material
a film substrate;
a laminating adhesive, a sputtered stack;
a second film layer;
a mounting adhesive; and
a release film.

5. The method of claim 4, wherein the film substrate comprises at least one of PET, PEN, and polycarbonate.

6. The method of claim 1, wherein the electromagnetic blocking filter is directly deposited on to the enclosure section.

7. The method of claim 1, wherein the electromagnetic blocking filter comprises two alternating layer pairs, said layer pair comprising a dielectric or metal oxide layer and a metal layer.

8. The method of claim 1, said electromagnetic blocking filter attenuates emissions in the frequency band through said section by at least 42 dB.

9. The method of claim 8, wherein the electromagnetic blocking filter comprises four layer pairs, said layer pair comprising a dielectric or metal oxide layer and a metal layer

10. The method of claim 8, wherein the electromagnetic blocking filter further comprises an additional dielectric or metal oxide layer

11. The method of claim 9, said electromagnetic blocking filter attenuates emissions in the frequency band through said section by at least 50 dB.

12. The method of claim 11, wherein the electromagnetic blocking filter comprises eight of said layer pairs.

13. The method of claim 1, wherein the electromagnetic blocking filter comprising a flexible transparent sheet configured for attachment to a glazing of a window.

14. The method of claim 13, wherein the electromagnetic blocking filter further comprises a safety film adhered to said glazing.

15. The method of claim 1, wherein the electromagnetic blocking filter comprises a first and a second filter portion, said first and second filter portions being spaced apart from each other.

16. The method of claim 15, wherein each of said spaced apart filter portions is embedded in spaced apart layers of polyvinylbutyral, wherein each polyvinylbutyral layer is sandwiched between layers of glass or plastic window glazing.

17. The method of claim 15, wherein the electromagnetic blocking filter comprises an upper layer comprising a first outer glass sheet joined to a first of said spaced-apart filter portions by a layer of PVB; and a lower layer comprising a second outer glass sheet joined to a second of said spaced-apart filter portions by a second layer of PVB, wherein said first and second of said spaced-apart filter portions s being adhesively secured to each other by a third layer of PVB or by an adhesive layer, and wherein said third layer of PVB and said adhesive having a thickness which determines a distance between said spaced-apart filter portions.

18. The method of claim 17, wherein said third layer of PVB or said adhesive is electrically conductive.

19. The method of claim 17, wherein the electromagnetic blocking filter comprises a layer of PVB or adhesive between the two filter portions, wherein the layer of PVB or adhesive is electrically conductive.

20. The method of claim 1, wherein the electromagnetic blocking filter comprises a sputtered dielectric or metal oxide layer and a metal layer.

21. The method of claim 20, wherein said dielectric or metal oxide layer comprises In₂O₃, TiO₂, Nb₂O₅, Ta₂O₅, SnO₂, ZnO or indium tin oxide (ITO).

22. The method of claim 20, wherein said metal layer comprises silver, gold, copper, or aluminum.

23. The method of claim 20, wherein the electromagnetic blocking filter further comprises an intermediate cladding layer or an intermediate adhesion layer.

24. The method of claim 1 further comprising the step of applying a first portion of the electromagnetic blocking filter to a first surface of said section and a second portion of the electromagnetic blocking filter to a second surface of said enclosure section.

25. The method of claim 1 wherein the electromagnetic blocking filter attenuates emissions in the frequency band entering the enclosure through said section by at least 30 dB.

26. A shielded wireless network comprising:
a wireless network, wherein the wireless network operates in a frequency band of electromagnetic emissions;
an enclosure surrounding the wireless network, within the enclosure has at least one section that is substantially transparent to the frequency band of electromagnetic emissions;
an electromagnetic blocking filter applied to said enclosure section, wherein said electromagnetic blocking filter attenuates emissions in the frequency band from the wireless network through said section by at least 30 dB and transmits at least 3% of visible light.

27. The shielded wireless network of claim 26, wherein said frequency band includes a range of 30 MHz to 10 GHz.

28. The shielded wireless network of claim 26 wherein the blocking filter is a flexible film type.

29. The shielded wireless network of claim 28, wherein the electromagnetic blocking filter comprises:
a hardcoat material
a Polyethylene Terephthalate (PET) film;
a laminating adhesive, a sputtered stack;
a PET film layer;
a mounting adhesive; and
a release film.

30. The shielded wireless network of claim 29, wherein the film substrate comprises at least one of PET, PEN, and polycarbonate.

31. The shielded wireless network of claim 26, wherein the electromagnetic blocking filter is directly deposited on to the enclosure section.

32. The shielded wireless network of claim 26, wherein the electromagnetic blocking filter comprises two alternating layer pairs, said layer pair comprising a dielectric or metal oxide layer and a metal layer.

33. The shielded wireless network of claim 26, said electromagnetic blocking filter attenuates emissions in the frequency band through said section by at least 42 dB.

34. The shielded wireless network of claim 33, wherein the electromagnetic blocking filter comprises four layer pairs, said layer pair comprising a dielectric or metal oxide layer and a metal layer

35. The shielded wireless network of claim 34, wherein the electromagnetic blocking filter further comprises an additional dielectric or metal oxide layer

36. The shielded wireless network of claim 35, said electromagnetic blocking filter attenuates emissions in the frequency band through said section by at least 50 dB.

37. The shielded wireless network of claim 36, wherein the electromagnetic blocking filter comprises eight of said layer pairs.

38. The shielded wireless network of claim 26, wherein the electromagnetic blocking filter comprises a first and a second filter portion, said first and second filter portions being spaced apart from each other.

39. The shielded wireless network of claim 38, wherein each of said spaced apart filter portions is embedded in spaced-apart layers of polyvinylbutyral, wherein each polyvinylbutyral layer is sandwiched between layers of glass or plastic window glazing.

40. The shielded wireless network of claim 39, wherein the electromagnetic blocking filter comprises an upper layer comprising a first outer glass sheet joined to a first of said spaced-apart filter portions by a layer of PVB; and a lower layer comprising a second outer glass sheet joined to a second of said spaced-apart filter portions by a second layer of PVB, wherein said first and second of said spaced-apart filter portions s being adhesively secured to each other by a third layer of PVB or by an adhesive layer, and wherein said third layer of PVB and said adhesive having a thickness which determines a distance between said spaced-apart filter portions.

41. The shielded wireless network of claim 39, wherein the electromagnetic blocking filter comprises a layer of PVB or adhesive between the two filter portions.

42. The shielded wireless network of claim 26, wherein the electromagnetic blocking filter comprises a sputtered dielectric or metal oxide layer and a metal layer.

43. The shielded wireless network of claim 42, wherein said dielectric or metal oxide layer comprises In₂O₃, TiO₂, Nb₂O₅, Ta₂O₅, SnO₂, ZnO or indium tin oxide (ITO).

44. The shielded wireless network of claim 42, wherein said metal layer comprises silver, gold, copper, or aluminum.

45. The shielded wireless network of claim 42, wherein the electromagnetic blocking filter further comprises an intermediate cladding layer or adhesion layer.

46. The shielded wireless network of claim 26, wherein the enclosure section comprises a first and a second layer and wherein a first portion of the electromagnetic blocking filter is applied to the first enclosure layer and a second portion of the electromagnetic blocking filter is applied to the layer of said enclosure section.

47. The shielded wireless network of claim 26 wherein the electromagnetic blocking filter attenuates emissions in the frequency band entering the enclosure through said section by at least 30 dB.

48. The shielded wireless network of claim 26, wherein the electromagnetic blocking film further comprises a sputtered metal stack, and wherein portions of the sputtered metal stack is integrally connected to one or more surfaces of the enclosure section.

49. The shielded wireless network of claim 26, wherein the enclosure section is substantially transparent to visible light.

50. A EMI shielding method comprising the steps of:
locating an EMI source transmitting in a frequency band of electromagnetic emissions;
providing an enclosure having at least one section that is substantially transparent to the frequency band of electromagnetic emissions;
applying an electromagnetic blocking filter to said enclosure section, wherein said electromagnetic blocking filter attenuates emissions in the frequency band from the wireless network through said section by at least 30 dB and transmits at least 3% of visible light.
